(19) United States
(12) Patent Application Publication
(10) Pub. No.: US 2005/0042078 A1
(43) Pub. Date: Feb. 24, 2005

(54) Isolated blower fan housing assembly

(76) Inventor: Brent J. Sturgell, Deltona, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/646,258

(22) Filed: Aug. 22, 2003

(51) Int. Cl. F03D 11/00

(52) U.S. Cl. 415/128

(57) ABSTRACT

An improved blower fan housing assembly is disclosed including an upper housing member of singular construction having integral sloping rear, top and front regions, a first side wall affixed to the upper housing member, the first side wall operatively engaged to at least one first isolation unit, and a second side wall affixed to the upper housing member, the second side wall operatively engaged to at least one second isolation unit.

### TECHNICAL FIELD OF THE INVENTION

The present invention relates to a housing assembly for containing a blower for use in heating and air conditioning units. More particularly, the present invention relates to an isolated blower housing assembly that reduces vibrations incidental to operation for use in units such as those employed in commercial and industrial installations.

### BACKGROUND OF THE INVENTION

Typically, residential and commercial heating, ventilation, and air conditioning (HVAC) units utilize centrifugal blowers that are forwardly curved to draw air into the HVAC units from the spaces to be heated or cooled and simultaneously force heated or cooled air from the units back into the spaces desired to be heated or cooled.

Centrifugal blowers that are forwardly curved are employed in HVAC units used for comparatively light duties and where it is desirable to keep the cost of the HVAC unit low. Compared with other centrifugal blowers, including backwardly inclined centrifugal blowers, the forwardly curved type is the relatively inexpensive to purchase and is also more lightweight in construction. It is thus required that the forwardly curved type be used at a low operating speed in order to avoid unsteady performance. In the alternative, backwardly inclined blowers are heavier and more expensive to manufacture than forwardly curved blowers, and have increased efficiency at higher operating speeds and pressures.

The selection of a HVAC unit for commercial or industrial installations by customers often requires consideration of the total cost to own a HVAC unit, as opposed to purchasing the least expensive equipment. The total cost of owning a HVAC unit includes initial equipment costs and the costs as well as operating costs of the equipment. Additionally, forwardly curved blowers are less efficient than blowers that are backwardly inclined. Therefore, HVAC units with forwardly curved blowers have a higher total cost due to their inefficiency

Furthermore, the widespread use of backwardly inclined blowers in these types of HVAC units has been hampered by the ease of installation and serviceability that the lighter weight, forwardly inclined blower affords. The forwardly curved blower and its associated housing are relatively light weight and is easier to slide out of the HVAC unit when service to the blower is required, more so than similarly installed backwardly inclined blower in the HVAC unit.

Another disadvantage associated with commercially available blowers, particularly the forwardly curved blade type, is the failure of the outlet opening of the blower housing assembly to produce an evenly distributed air flow to the heating coils. The heating coils are frequently located directly adjacent to the discharge opening of the blower. An unevenness in the air flow around the heating coils decreases the efficiency of the heat transfer process occurring between the heating coils and the air flowing around those coils, thereby additionally decreasing the overall efficiency of the performance of the HVAC unit.

Blower assemblies can also include slide rails for being slidably received by horizontal tracks that are connected to the horizontal partition or supporting wall. Frequently, the tracks include cushioning strips secured to the surfaces that support the rails in the blower housing. These cushioning strips serve the purposes of shock absorption as well as promoting a seal between the horizontal supporting wall and the blower housing. Moreover, front and rear sealing strips are typically provided to complete the seal between the outlet of the blower housing and the horizontal supporting wall.

The present invention addresses these problems by providing an improved blower fan housing assembly that employs a plurality of isolation units to dampen vibrations resulting from blower operation. The present invention is additionally provided with an upper housing member of singular construction having integral sloping rear, top and front regions. The present invention results in increases in efficiency and quiet operation.

Additionally, slidable mounts can be provided so that the present invention can be easily inserted or removed from a HVAC unit to conduct repairs or replacement. Because the fan supply motor is releasably mounted onto the slanted wall of the invention, the motor is removed as a unit with the blower fan, unlike units employing conventional forwardly curved blowers where the blower and its supply motor are separately attached to the HVAC unit. By having the supply motor attached directly to the blower fan housing of the present invention, the belt, the fan pulley and the supply motor pulley can be aligned and adjusted while the components are removed from the confines of the HVAC unit, further contributing to its ease in servicing.

### SUMMARY OF THE INVENTION

The present invention eliminates the above-mentioned needs for an improved blower fan housing assembly by providing an improved blower fan housing assembly that employs a plurality of isolation units to dampen vibrations resulting from blower operation.

In accordance with the present invention, there is provided an improved blower fan housing assembly, including an upper housing member of singular construction having integral sloping rear, top and front regions, a first side wall affixed to the upper housing member, the first side wall operatively engaged to at least one first isolation unit, and a second side wall affixed to the upper housing member, the second side wall operatively engaged to at least one second isolation unit.

The present invention is additionally directed to an improved blower fan housing assembly, including an upper housing member of singular construction having integral sloping rear, top and front regions, a first side wall affixed to the upper housing member, the first side wall operatively engaged to at least one first isolation unit, a second side wall affixed to the upper housing member, the second side wall operatively engaged to at least one second isolation unit, and a slidable motor mount operatively engaged to the first and second side walls.

### BRIEF DESCRIPTION OF THE DRAWINGS

FIG. 1 is an exploded isometric view of the preferred embodiment of the present invention.

FIG. 2 is an isometric view of the present invention of FIG. 1.

FIG. 3 is a side view of the present invention of FIG. 1.

FIG. 4 is a rear view of the present invention of FIG. 1.

FIG. 5 is a top view of the present invention of FIG. 1.

### DETAILED DESCRIPTION

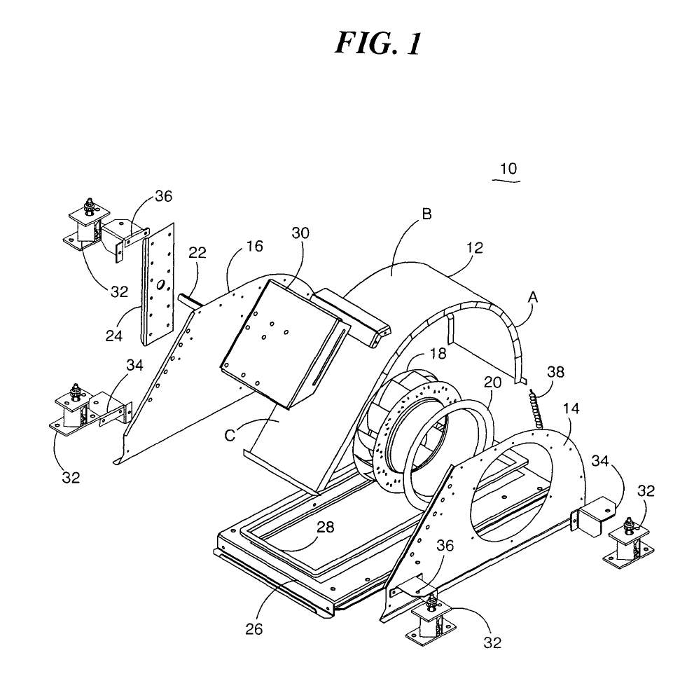

Referring now to FIG. 1, a preferred embodiment of the present invention is illustrated as isolated wrapper housing 10. Isolated wrapper housing 10 includes upper housing member 12, first side wall 14, and second side wall 16.

Upper housing member 12 is a piece of singular construction having integral sloping rear, top and front regions, A, B, and C respectively. Forming upper housing member 12 from a single piece reduces the amount of air that leaks out of the housing, a problem common in the prior art. Additionally, by incorporating a slope, or curve, to the entire upper housing member 12, edges on the interior of upper housing member 12 are eliminated, thereby reducing or eliminating the ability for air to become trapped or stagnant in the interior spaces of isolated wrapper housing 10. By reducing the amount of trapped or stagnant air, air flow efficiency is increased. An additional benefit to sloped or curved upper housing member 12 is that a more efficient, less turbulent air flow results, thereby resulting in better heat transfer, as well as a reduction in noise emitted from isolated wrapper housing 10.

Upper housing member 12 is affixed to a first side wall 14 and a second side wall 16. First and second side walls 14 and 16 can be affixed to upper housing member 12 in a variety of ways, including, but not limited to, bolting, welding, fastening, adhering, and the like. First side wall 14 includes an opening for the intake of air to a blower fan assembly, such as fan 18, venture inlet 20, and shaft 22. Second side wall 16 includes a passage for shaft 22, and is capable of supporting a blower fan mount 24.

Upper housing member 12 and first and second side walls 14 and 16 are secured to a bottom slider plate 26. In order to reduce vibration, noise, and air leakage, a gasket 28 is affixed to bottom slider plate 26. Bottom slider plate 26 includes an air passage to permit air flow and can be slidably supported on tracks or the like in order to permit access for servicing.

First and second side walls 14 and 16 additionally support motor mount 30. Motor mount 30 can be affixed to first and second side walls 14 and 16 in a variety of ways, including, but not limited to, bolting, fastening, and the like. Motor mount 30 supports a motor (not shown), as is generally known in the art. Typically, the motor is provided with a motor shaft having a pulley secured thereto. The pulley additionally operationally engages a belt to engage shaft 22 so as to drive blower fan 18.

Since motor mount 30 is positioned on angled portions of first and second side walls 14 and 16, the motor may be slid towards top region B of upper housing member 12. This sliding action reduces the tension on the drive belt so as to facilitate its replacement.

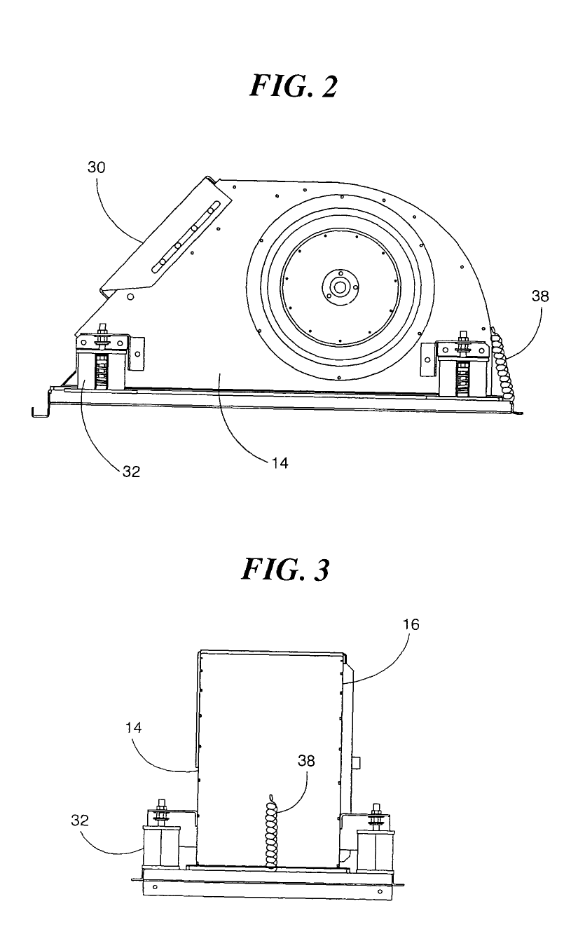

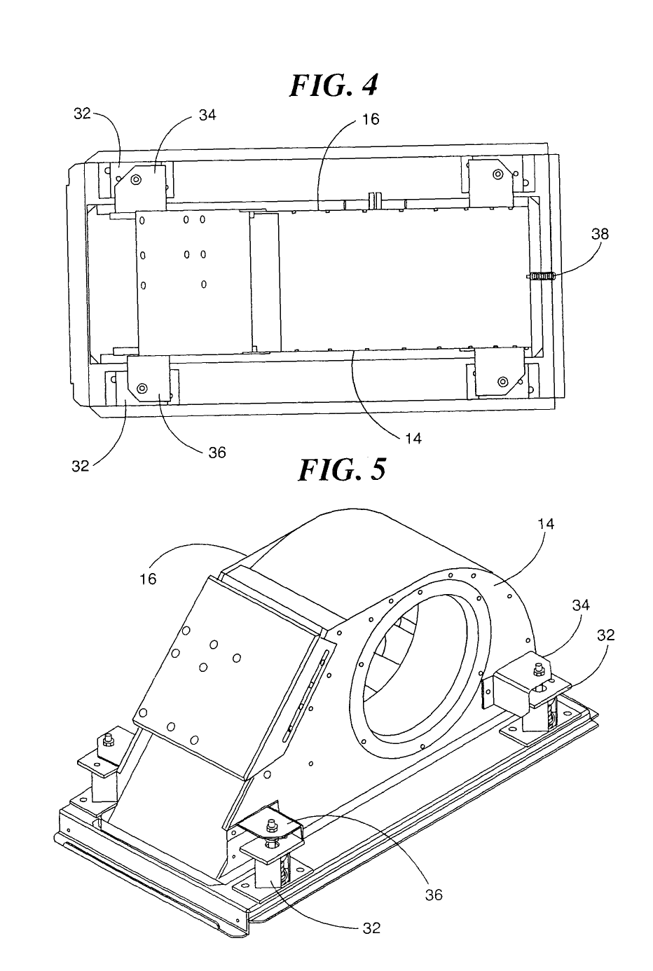

Additionally, as illustrated in FIGS. 2, 3, 4 and 5, first and second side walls 14 and 16 support a plurality of isolation units 32. Isolation units 32 can be supported through an array of manners known in the art, including but not limited to, mounts, brackets, fasteners, and the like. It is preferred that isolation units 32 are supported by mounts 34 and 36. Mounts 34 and 36 are affixed directly to first and second side walls 14 and 16 in a manner consistent with the general skill in the art. Isolation units 32 assist in the further reduction of vibration and noise resulting from the use of blower fan 18 and the resulting air movement. Isolation units 32 are preferably spring-loaded, however they can be constructed to use numerous vibration-reducing materials, including but limited to rubber (as with rubber grommets or stoppers), or other compressible polymer materials. Furthermore, isolation units 32 can be secured to bottom slider plate 26. Securing isolation units 32 to bottom slider plate 26 facilitates further reduction in vibration.

By incorporating a compressible structure or materials, isolation units 32 dampen vibrations that result from the transfer of kinetic energy between the motor, blower 18, air, upper housing member 12, side walls 4 and 16, and bottom slider plate 26.

Further reduction in vibration can be accomplished through the use of a thrust resister spring 38. Thrust resister spring 38 engages both sloping rear region A and bottom slider plate 26. Thrust resister spring 38 provides a degree of flexible tension so as to dampen vibrations of isolated wrapper housing 10.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

1. An improved blower fan housing assembly, comprising:
an upper housing member of singular construction having integral sloping rear, top and front regions;
a first side wall affixed to said upper housing member, said first side wall operatively engaged to at least one first isolation unit; and
a second side wall affixed to said upper housing member, said second side wall operatively engaged to at least one second isolation unit.

2. The assembly according to claim 1 further compromising:
a slider plate engaging said upper housing member;
a motor mount slidably engaging said first and second side walls; and
at thrust resister spring operationally engaged to said upper housing member and said slider plate.

3. The assembly according to claim 1 wherein said at least one first isolation unit is identical to said at leas one second isolation unit.

4. The assembly according to claim 1 wherein said at least one first isolation unit is spring-loaded.

5. The assembly according to claim 1 wherein said at least one first isolation unit incorporates a compressible material to reduce vibration.

6. The assembly according to claim 5 wherein said compressible material is rubber.

7. The assembly according to claim 1 wherein said at least one second isolation unit is spring-loaded.

8. The assembly according to claim 1 wherein said at least one second isolation unit incorporates a compressible material to reduce vibration.

9. The assembly according to claim 7 wherein said compressible material is rubber.
